(19) United States
(12) Patent Application Publication
(10) Pub. No.: US 2015/0177073 A1
(43) Pub. Date: Jun. 25, 2015

(54) HIGH TEMPERATURE MEASURING SENSOR ARRANGEMENT

(71) Applicant: TESONA GMBH & CO. KG, Hörselberg/Hainich (DE)

(72) Inventor: Heiko Lantzsch, Eisenach (DE)

(21) Appl. No.: 14/415,700

(22) PCT Filed: Jul. 9, 2013
(86) PCT No.: PCT/EP2013/064455

§ 371 Date: Jan. 19, 2015

(30) Foreign Application Priority Data
Jul. 18, 2012 (DE) 102012014245.5
May 28, 2013 (DE) 102013009033.4

(51) Int. Cl. G01K 1/12; G01K 13/00; G01K 1/16

(52) U.S. Cl. CPC G01K 1/12; G01K 1/16; G01K 13/00

(57) ABSTRACT

A high temperature measuring sensor arrangement, includes a sensor element located in a shield tube with a measuring section exposed at the end of the shield tube and oriented towards the hot side and connections opposite this, facing towards the cold side, with a protective cap connected to the shield tube and enclosing the measuring section and a first stabilizing and fastening sleeve directed towards the hot side. The first stabilizing and fastening sleeve overlays the protective cap at the end and provides stabilization against vibrational forces, while thermal expansions in the longitudinal axis direction are absorbed by the joint between the protective cap and the first stabilizing and fastening sleeve. A second stabilizing and fastening sleeve directed towards the cold side is provided, overlaying the shield tube at the connection-side end, wherein the first and/or second stabilizing and fastening sleeve has a reduced diameter in the region of the joint and overlay.

The invention relates to a high-temperature measuring sensor arrangement comprising a sensor element located in a protecting tube with a measuring section exposed at the end of the protecting tube and oriented towards the hot side and opposite connections pointing towards the cold side, further with a protective cap connected to the protecting tube and enclosing the measuring section and a first stabilizing and fastening sleeve directed towards the hot side, according to patent claim 1.

A temperature sensor comprising a thermal element is already known from WO 2010/063682 A1, which includes a sheathed fireproof cable on whose end facing the measuring medium a sensor element is arranged. Electrical connecting leads for connecting the sensor element to an electronic evaluation unit are led through a metal tube of the sheathed cable. The temperature sensor described is to be usable at temperatures up to 1200° C. and capable of detecting fast temperature changes. To this end, the sensor element is formed of a thermo wire bead which protrudes from the sheathed cable and is received by a protective sleeve that is attached to the end of the sheathed cable facing the measuring medium. The protective sleeve comprises a one-piece front part, without any welding points, and the sheathed cable is a flexible, thin-walled metal tube with a small outer diameter on whose end facing away from the measuring medium connecting wires are led out which produce the desired connection to the on-board electronic system.

A high-temperature sensor comprising a sensor element is already known from the generic EP 2 196 787 A2 document, which is mounted in a protecting tube. To allow the performance of reliable measurements also in high-temperature environments, e.g. the exhaust gas system of a motor vehicle the protecting tube is surrounded by a reinforcement tube, the reinforcement tube being made of a material whose thermal expansion coefficient is higher than that of the material of which the protecting tube is formed. The stiffening tube is fixedly connected to the protecting tube in a first region of the protecting tube, and an abutment element is located in the second region of the protecting tube which is likewise fixedly connected to the protecting tube. The reinforcement tube, owing to its greater thermal expansion, comes into mechanical contact with the abutment element above a predefined temperature, whereby the high-temperature sensor is mechanically stabilized above this temperature. According to EP 2 196 787 A2 the space between the sensor element and the protecting tube cap is filled with a material having good heat-conducting properties. To this end, a fine silicon powder may be used. The stabilizing, mechanical contacting of the protecting tube with the abutment element requires a minimum temperature, so that in particular directly in the starting phase, that is, not yet in the high-performance operation, the overall assembly is prone to vibrations that jeopardize the reliability of the measuring arrangement.

Based on the foregoing it is therefore the object of the invention to provide an improved high-temperature measuring sensor arrangement which starts out from a sensor element mounted in a protecting tube, and wherein a measuring section or a measuring bead, in particular a thermoelement measuring bead, is located at the end of the protecting tube, oriented towards the hot side. It is desired that the high-temperature measuring sensor arrangement to be provided is producible in a cost-efficient manner, and has a high stability and small failure rate. Moreover, a fast response of the sensor element should be possible so as to ensure an optimum operation of a correspondingly equipped motor vehicle or motor vehicle engine, a turbocharger, or a stationary engine. One key aspect on the object side consists in the stabilization of the sensor element, located in the protecting tube, with respect to vibrations and respective mechanical and thermal loads in the exhaust gas flow of an internal combustion engine.

The solution to the object of the invention is achieved by combining the features defined in patent claim 1. The dependent claims describe at least useful embodiments and further developments.

Accordingly, there is proposed a high-temperature measuring sensor arrangement comprising a sensor element located in a protecting tube with a measuring section exposed at the end of the protecting tube and oriented towards the hot side and opposite connections pointing towards the cold side. Moreover, there is provided a protective cap connected to the protecting tube and enclosing the measuring section and a first stabilizing and fastening sleeve directed towards the hot side.

According to the invention, the stabilizing and fastening sleeve directed towards the hot side overlays the protective cap at the end thereof pointing towards the protective cap and provides stabilization against vibrational forces. The chosen joining connection allows the absorption of thermal expansions in the direction of the longitudinal axis, present between the protective cap and the first stabilizing and fastening sleeve, without a mechanical destruction or the occurrence of damage.

Furthermore, a second stabilizing and fastening sleeve directed towards the cold side is provided, which overlays the protecting tube at the connection-side end and supports the protecting tube, wherein the first and the second stabilizing and fastening sleeves are designed with a reduced diameter in the region of the joint and the overlay.

The above-mentioned overlaying takes place, on the one hand, relative to the longitudinal axis of the overall arrangement to provide for a stabilization against vibrational forces. On the other hand, the overlaying is realized as a joining connection between the protective cap and the first stabilizing and fastening sleeve such that thermal expansions in the direction of the longitudinal axis can be absorbed. The joint between the aforementioned elements is maintained across the entire region of the thermal expansion in the direction of the longitudinal axis of the overall arrangement, however, so that the desired mechanical stability and the freedom from vibrations of the measuring section are guaranteed.

Preferably, the joining connection is realized with the opposing generated surfaces of the aforementioned elements.

According to the invention, the joining connection allows a sliding between the protective cap and the inner wall of the first stabilizing and fastening sleeve, respectively, between the outside of the protecting tube and the inner wall of the second stabilizing and fastening sleeve which is located at the cold end of the measuring sensor arrangement.

For producing the joining connection the protective cap includes, in a preferred embodiment, protrusions and recesses that run radially on the circumference, preferably in the direction of the longitudinal axis.

In an alternative embodiment the second stabilizing and fastening sleeve and the protecting tube can be pressed together.

For the access of the medium to be measured the protective cap may comprise openings, e.g. slot-shaped openings.

In one embodiment, the protective cap comprises a substantially cylindrical end section which immerses into a complementary cylindrical end section of the first stabilizing and fastening sleeve, thereby optimizing the mechanical stabilization of the overall arrangement.

If the aforementioned cylindrical end sections have a reduced diameter a minimized heat capacity is obtained, in particular in the region of the measuring section, which results in a faster response of the overall arrangement in the event of corresponding temperature changes.

According to another inventive approach the protective cap has a filling of a vibration-stabilizing, thermally conductive, preferably powdery material.

In one embodiment, the filling is shaken in, preferably by applying ultrasound or other mechanical vibrations, viz. when the measuring section already immerses into the protective cap, respectively, is enclosed by the protective cap. This results in a reproducible compaction of the filling material without interfering forces affecting the measuring section, respectively, connecting wires or sheathed lines inside the protecting tube. The compaction of the filling is preferably accomplished without an external action of forces. A deformation by compression of the protective cap is thus prevented.

According to a further development the filling may also be realized in the form of a layered filling. In this case, the filling consists of at least two layers running perpendicular to the direction of the longitudinal axis, wherein a first layer surrounding the measuring section has a very high thermal conductivity and a second layer pointing away from the measuring section has a reduced thermal conductivity.

Thus, an undesired heat dissipation in the direction of the cold end of the overall arrangement can be reduced, respectively, the heat conduction into this direction can be reduced, which is a particular advantage in dynamic measuring processes and high-temperature applications.

In a preferred embodiment the filling material contains boron nitride particles or is made of boron nitride material. A directed orientation of the boron nitride particles during the filling process or directly subsequent to the filling process allows an adjustment of the direction of the heat conduction towards the measuring bead. This ensures that the heat transport perpendicular to the direction of the longitudinal axis of the overall arrangement is improved, whilst being subjected to a reduction in the direction of the longitudinal axis, i.e. towards the cold side.

It is furthermore possible to lead the ends of the first and second stabilizing and fastening sleeves, pointing towards each other, onto a thrust collar, respectively, flange or pressure screw, formed in particular as a hollow screw, and fix them there by welding. The flange, respectively, thrust collar itself may be formed as a thermal shield. It is also possible, however, to arrange additional radiation shielding elements on the flange or on the thrust collar, respectively, hollow screw in order to protect downstream, in particular electronic units or connection parts against an unnecessary thermal effect.

According to a further development of the invention the second stabilizing and fastening sleeve is surrounded by a protective sleeve which receives an insulating part as well as at least one seal and the electronic connections for the external further processing of signals. The surface of the insulating part is pressed against the surface of the protective sleeve.

According to a preferred embodiment it is possible, depending on the diameter of the sensor element located in the protecting tube, to provide a sleeve-shaped adapter part, if necessary with a stepped diameter, so that dimensionally unitary stabilizing and fastening sleeves can be used in particular on the cold side.

The invention will be explained in more detail below by means of an exemplary embodiment and with the aid of figures. In the drawings:

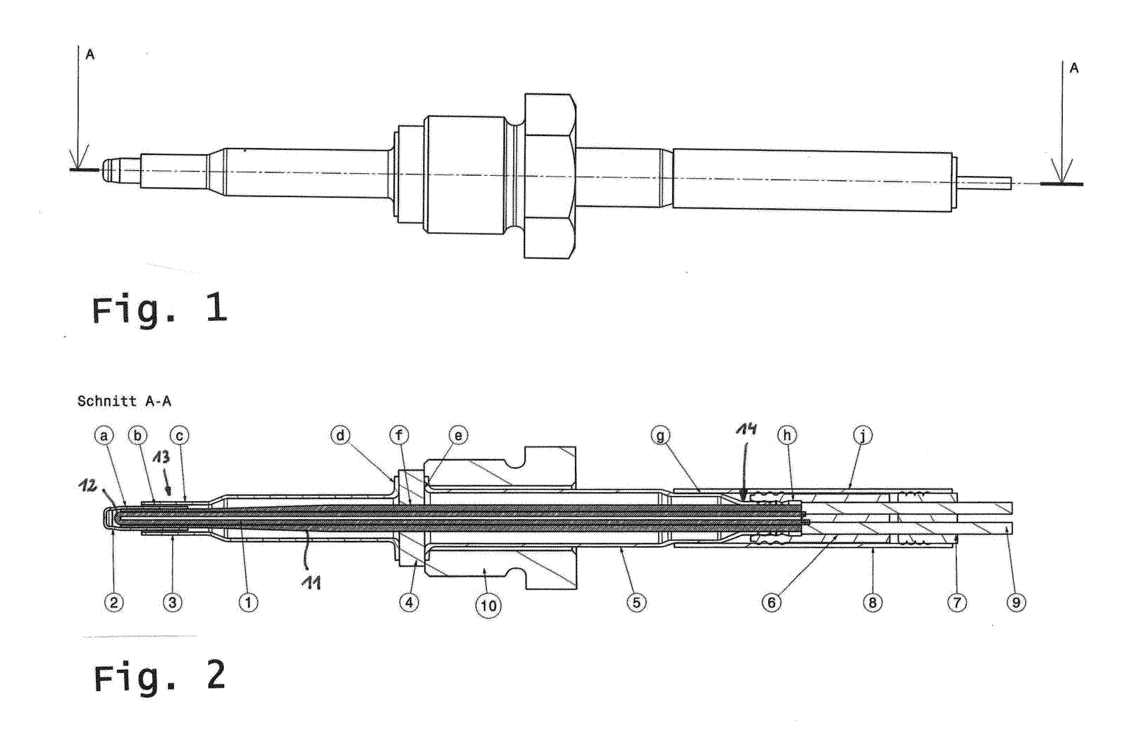

FIG. 1 shows a lateral view of the high-temperature measuring sensor arrangement according to the invention;

FIG. 2 shows a longitudinal section through the arrangement of FIG. 1;

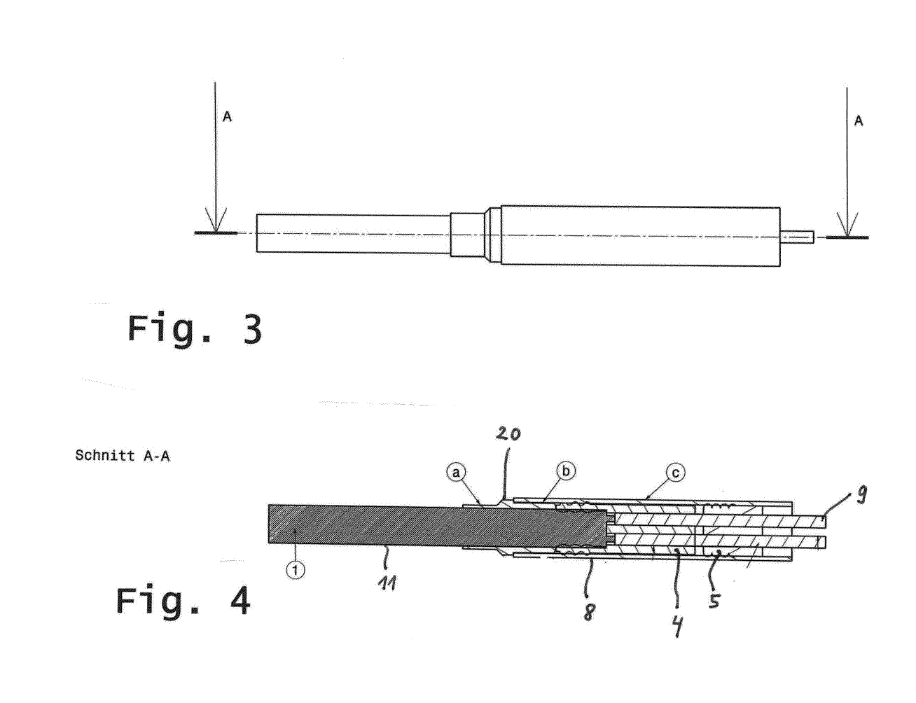

FIG. 3 shows a lateral view of the further development of the invention including an adapter and protective sleeve at the cold end of the sensor arrangement; and

FIG. 4 shows a section along line A-A of the arrangement of FIG. 3.

The high-temperature measuring sensor arrangement according to the figures proceeds from a sheathed line 1 located in a protecting tube 11.

The sheathed line 1 comprises a measuring section 12. This measuring section 12 may also be designed as a measuring bead.

The measuring section 12 is located at the exposed end of the protecting tube 11.

A protective cap 2 surrounds the measuring section 12 and a portion of the protecting tube 11.

A first stabilizing and fastening sleeve 3 directed towards the hot side is connected to the protective cap 3 at the end thereof pointing towards the protective cap 2. In particular, a joining connection is here realized, which achieves a stabilization against vibrational forces and, furthermore, makes it possible that thermal expansions in the direction of the longitudinal axis can be absorbed between the protective cap 2 and the first stabilizing and fastening sleeve 3.

In addition, a second stabilizing and fastening sleeve 5 directed towards the cold side is provided.

This second stabilizing and fastening sleeve 5 overlays the protecting tube 11, and supports same, at the end of the connection side.

In the joining and overlaying regions 13; 14 the first and/or second stabilizing and fastening sleeves 3; 5 have a reduced diameter, respectively, are tapered.

The second stabilizing and fastening sleeve 5 may be pressed against the protecting tube 11 in region 14.

In the embodiment according to FIG. 2, the second stabilizing and fastening sleeve 5 is surrounded by a protective sleeve 8 which receives an insulating part 6 and at least one seal 7, so that the connections 9 can be passed out of the overall arrangement electrically insulated and sealed.

The first and second stabilizing and fastening sleeves 3; 5 are led, with their ends pointing towards each other, onto a thrust collar 4 and/or a hollow screw 10 and can be connected with corresponding surfaces of these elements by welding.

Reference number a symbolizes the region of a connection realized by pressing and/or welding. Reference number b represents the region of the joining connection, reference number c a region where surface is pressed against surface, reference numbers d and e the welding region, reference number f an optional welding region, reference number g, again, an optional welding region, reference number h a pressing region, and reference number j a surface-to-surface pressing region.

The supporting sleeve on the hot side stabilizes the element against vibrations and strong loads in the exhaust gas tube. An additional stabilization is achieved by the supporting sleeve on the cold side, the proposed construction being additionally capable of detecting temperature differences in the screw connection area (of the hollow pressure screw) so that measuring faults and, to a certain extent, also installation faults can be compensated.

To allow the use of thermoelements with different diameters it is proposed, according to FIGS. 3 and 4, to use a adapter 20 which encompasses the sheathed line 1, respectively, the protecting tube 11.

Depending on the diameter of the sensor element located in the protecting tube 11, the adapter 20, respectively, adapter part 20 is designed to allow the use of dimensionally unitary stabilizing and fastening sleeves in particular on the cold side.

The connection technologies for the aforementioned parts in the illustration according to FIG. 4 can be realized by a welded, respectively, pre-pressed connection according to reference number a, by a welded connection according to reference number b, and by a surface-to-surface-pressed connection according to reference number c.

1. A high-temperature measuring sensor arrangement comprising a sensor element located in a protecting tube with a measuring section exposed at an end of the protecting tube and oriented towards a hot side and opposite connections pointing towards a cold side, further with a protective cap connected to the protecting tube and enclosing the measuring section and a first stabilizing and fastening sleeve directed towards the hot side, wherein:
the first stabilizing and fastening sleeve directed towards the hot side overlays the protective cap at the end thereof pointing towards the protective cap and provides stabilization against vibrational forces, wherein thermal expansions in a direction of a longitudinal axis are absorbed by a joining connection between the protective cap and the first stabilizing and fastening sleeve, and
a second stabilizing and fastening sleeve directed towards the cold side is provided, which overlays the protecting tube at the connection-side end and supports the protecting tube, wherein the first and/or the second stabilizing and fastening sleeves are designed with a reduced diameter in a region of the joint and the overlay and, for a remainder of the first and/or second stabilizing and fastening sleeves, are designed with a distance to the protecting tube.

2. The high-temperature measuring sensor arrangement according to claim 1, wherein:
the joining connection is realized with opposing generated surfaces.

3. The high-temperature measuring sensor arrangement according to claim 1, wherein:
the joining connection allows sliding between the protective cap and an inner wall of the first stabilizing and fastening sleeve.

4. The high-temperature measuring sensor arrangement according to claim 1, wherein:
the second stabilizing and fastening sleeve and the protecting tube are pressed together.

5. The high-temperature measuring sensor arrangement according to claim 1, wherein:
the second stabilizing and fastening sleeve is surrounded by a protective sleeve which receives an insulating part as well as at least one seal and connections.

6. The high-temperature measuring sensor arrangement according to claim 1, wherein:
the protective cap comprises a substantially cylindrical end section which immerses into a complementary cylindrical end section of the first stabilizing and fastening sleeve.

7. The high-temperature measuring sensor arrangement according to claim 6, wherein:
the respective cylindrical end sections have a reduced diameter with a minimized heat capacity.

8. The high-temperature measuring sensor arrangement according to claim 1, wherein:
the protective cap has a filling of a vibration-stabilizing, thermally conductive, powdery material.

9. The high-temperature measuring sensor arrangement according to claim 8, wherein:
the filling is shaken in by applying ultrasound.

10. The high-temperature measuring sensor arrangement according to claim 8, wherein:
the filling includes at least two layers running perpendicular to the direction of the longitudinal axis, wherein a first layer surrounding the measuring section has a high thermal conductivity and a second layer pointing away from the measuring section has a reduced thermal conductivity.

11. The high-temperature measuring sensor arrangement according to claim 8, wherein:
the filling material contains boron nitride, wherein by a directed orientation of the boron nitride particles during the filling process or directly subsequent to the filling process, the direction and/or the extent of heat conduction towards the measuring section can be adjusted.

12. The high-temperature measuring sensor arrangement according to claim 1, wherein:
the ends of the first and second stabilizing and fastening sleeves, pointing towards each other, are led onto a thrust collar and/or hollow pressure screw and are connected to the thrust collar or hollow pressure screw.

13. The high-temperature measuring sensor arrangement according to claim 1, wherein:
a sleeve-shaped adapter part is provided based on a diameter of the protecting tube including the sensor element, so that dimensionally unitary stabilizing and fastening sleeves are used on the cold side.
